(19) United States
(12) Patent Application Publication
(10) Pub. No.: US 2013/0055346 A1
(43) Pub. Date: Feb. 28, 2013

(54) Event Driven Multi-Factor Authentications For Internet Transactions

(71) Applicants: Harpreet Singh, Bolingbrook, IL (US); Prabhakar Rangarao, Naperville, IL (US); Sanjeev Mahajan, Naperville, IL (US)

(72) Inventors: Harpreet Singh, Bolingbrook, IL (US); Prabhakar Rangarao, Naperville, IL (US); Sanjeev Mahajan, Naperville, IL (US)

(73) Assignee: Alcatel-Lucent USA Inc., Murray Hill, NJ (US)

(21) Appl. No.: 13/217,724

(22) Filed: Aug. 25, 2011

(51) Int. Cl. H04L 9/32

(52) U.S. Cl. 726/3

(57) ABSTRACT

An event-driven multi-factor authentication system for internet transactions is implemented in a communication system including a user platform operably connected to an application platform. In embodiments described herein, the application platform receives and evaluates event data associated with one or more online transactions of the user to identify occurrences of any triggering events; and upon occurrences of triggering events, identifies and issues one or more predefined authentication challenges corresponding to the triggering events. The triggering events may comprise, without limitation, amount-based events, time-based events or geography-based events. In such manner, for example, multi-factor authentications may be triggered for transactions having specified monetary amounts, amounts within a specified time period, or initiated from certain geographic locations. The authentication challenges may characterize different numbers of authentication challenges (including, without limitation, a combination of single- and multi-factor authentication) for different events.

### BACKGROUND OF THE INVENTION

1. Field of the Invention

This invention relates generally to communications systems such as the Internet and, more particularly, to a manner of triggering multi-factor authentication challenges for internet transactions based on user-configurable events.

2. Statement of the Problem

The Internet is a well-known communication system in which users may access and interact with various web-based platforms to conduct online transactions. For example and without limitation, a user may go online to conduct electronic commerce, mobile commerce or online banking transactions and they may access online information content such as account balances, medical records or the like by accessing and interacting with the appropriate web-based platforms.

Customer authentication is a necessity for such transactions to reduce instances of fraud and to protect customer privacy. In many instances, however, authentication is accomplished in a very rudimentary fashion involving only username and password authentication (characterizing a “one-step” sign-on process). Although such simple authentication can be useful for some transactions, it is inherent that the simpler the authentication mechanism, the greater the security risk; and the security risk is heightened by the increasing use of smart phones as customers are now making the transactions in public places. Accordingly, depending for example on the monetary amount, the time of day or location of a transaction, there are instances where multi-factor authentication (i.e., requiring multiple authentication challenges) would be preferable to the one-step sign on process.

Multi-factor authentication is well known. For example and without limitation, multi-factor authentication may involve some form or combination of additional challenges comprising passwords, PINs, personal questions, biometric information, special issued cards/tokens, or phone calls to a specific number. A user might select multi-factor authentication challenges, for example, coincident to creating or modifying a user profile and/or privacy settings associated with a particular web platform from which they will conduct online transactions. Presently, however, short of resetting their user profile, users have little flexibility in controlling the number and/or type of authentication parameters to be used on a transaction by transaction basis. In other words, a web platform having been arranged to use multi-factor authentication for a particular customer will use the same authentication parameters for every consecutive transaction until such time as the customer might periodically change the authentication parameters in their user profile, which can be a cumbersome and time-consuming process.

### SUMMARY OF THE SOLUTION

These problems are addressed by providing a user-configurable event-driven multi-factor authentication solution for online transactions, wherein the number and/or type of authentication parameters to be used for individual transactions are determined based on certain events defined by the user. The events may comprise, without limitation, amount-based events, time-based events or geolocation-based events. In such manner, for example, multi-factor authentications may be triggered for transactions having specified monetary amounts, amounts within a specified time period, or initiated from certain geographic locations.

In one embodiment, there is provided an apparatus for providing event-driven authentication associated with one or more online transactions of a user, in accordance with a communication system including a user platform operably connected to an application platform, the apparatus at the application platform comprising a memory and a processor, the processor configured to receive event data associated with one or more online transactions of the user; and evaluate the event data relative to a plurality of predefined event conditions to identify occurrences of any triggering events. Upon occurrence of at least one triggering event, the processor is configured to identify authentication challenge rules corresponding to the at least one triggering event and issue one or more authentication challenges according to the authentication challenge rules.

In one embodiment, there is provided a method for providing event-driven authentication associated with one or more online transactions of a user, in accordance with a communication system including a user platform operably connected to an application platform, the method comprising the application platform receiving event data associated with one or more online transactions of the user and evaluating the event data relative to a plurality of predefined event conditions to identify occurrences of any triggering events. Upon occurrence of at least one triggering event, the application platform is configured to identify authentication challenge rules corresponding to the at least one triggering event and issue one or more authentication challenges according to the authentication challenge rules.

In either of the above-described embodiments, the at least one triggering event may comprise any combination of: amount-based events, wherein the predefined event conditions comprise indicia of individual transaction amounts; time-based events, wherein the predefined event conditions comprise indicia of cumulative transaction amounts over a specified time period; and geography-based events, wherein the predefined event conditions comprise indicia of where respective transactions are initiated relative to a specified geographic area.

### DESCRIPTION OF THE DRAWINGS

FIG. 1 is a block diagram of a communication system implementing event-driven multi-factor authentications according to embodiments of the present invention.

FIG. 2 is a flowchart showing steps performed to execute an event definition and rule creation process associated with multi-factor authentications according to embodiments of the present invention.

FIG. 3 is a flowchart showing steps performed to execute an event-based challenge process associated with multi-factor authentications according to embodiments of the present invention.

### DETAILED DESCRIPTION OF THE INVENTION

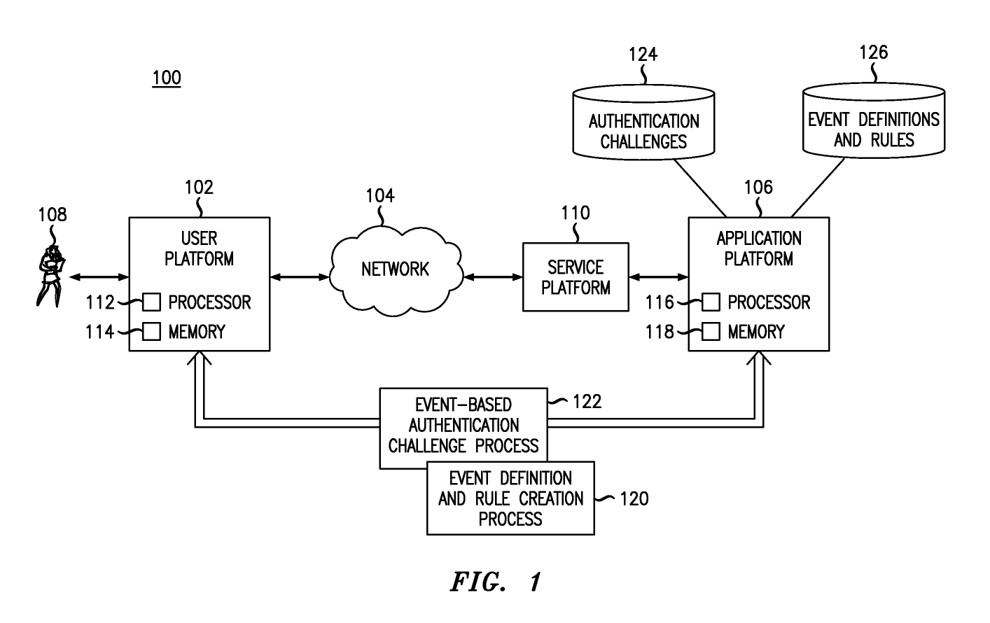

FIG. 1 illustrates a communication system 100 capable of implementing event-driven multi-factor authentications according to embodiments of the present invention. The communication system 100 includes a user platform 102 interconnected by a communication network 104 to a service platform 110 which, in turn, is connected to an application platform 106. The user platform 102 may comprise, for example and without limitation, a laptop computer, desktop computer or mobile computing device, nominally including a web brower, and which is subject to operation by a user 108 (i.e., person) to interact with the service platform 110 to conduct an online transaction. The service platform 110 may comprise, for example and without limitation, a web server hosting a website with which the user is conducting an online transaction. The application platform 106 may comprise, for example and without limitation, a computer device or software application residing remotely from the user platform that executes an application program to implement event-driven multi-factor authentications in conjunction with the user platform. The application platform 106 is a functional element that may reside within one or more physical devices and may be colocated or remote from the service platform 110. Alternatively, transactions or segments of transactions associated with event-driven multi-factor authentications may be executed independently by the user platform 102.

The network 104 comprises generally any communication medium operable to link the user platform 102 to the service platform 110 and application platform 106. The network 102 may comprise, without limitation, an IP Multimedia Subsystem (IMS) network, a wireless network (e.g., CDMA-based, GSM-based or LTE-based network), a circuit-switched network, a packet-based network (IP network) or another type of network.

The user platform 102 and application platform 106 each include a processor and memory for effecting transactions or segments of transactions between the respective platforms. As shown, the user platform 102 includes processor 112 and memory 114; and the application platform 106 includes processor 116 and memory 118. Generally, the processors 112, 116 are operable to execute respective program code (e.g., including but not limited to operating system firmware/software and application software) stored in the respective memory 114, 118, the execution of which depends at least in part from commands issued from the user 108.

According to embodiments of the present invention, the transactions or segments of transactions carried out between the respective platforms include an event definition and rule creation process 120 and an event-based authentication challenge process 122 associated with multi-factor authentications. The application platform 106 is operably connected to and consults one or more databases when carrying out the respective processes. As shown, the databases include an authentication challenge database 124 and an event definition and rules database 126. As will be appreciated, the respective databases may be implemented in one or more physical devices and may be linked to the user platform 102 as well as the application platform 106.

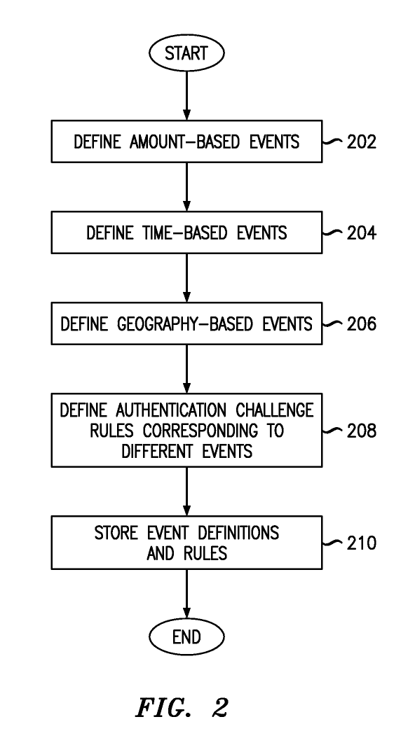

FIG. 2 is a flowchart showing steps associated with the event definition and rule creation process 120 according to an embodiment of the present invention. Generally, the event definition and rule creation process 120 operates to define various event conditions, the occurrence of which defines respective “events” (or “triggering events”) for purpose of triggering authentication authentication challenges; and corresponding rules specifying, for example, how many and/or which type of challenges are to be triggered. The steps of FIG. 2 may be performed, for example, by the user 108 via operation of the user platform 102 in conjunction with the application platform 106 and/or the service platform 110 where applicable. It is contemplated, for example, that the user 108 may define event conditions and/or rules via the user platform 102 (e.g., by conveying information and/or instructions associated with the event conditions and/or rules to the application platform 106 and/or service platform 110 via keystroke or keypad entries, voice commands or the like). Alternatively or additionally, event conditions and/or rules may be generated externally (e.g., by the application platform 106, service platform 110 or another third party or third party platform) and communicated to the user 108 for selection or confirmation via the user platform 102.

At step 202, the user defines (or selects, depending on implementation) amount-based event conditions. In one embodiment, amount-based event conditions comprise event conditions that are based on an individual transaction amounts (in currency) relative to a threshold value. For example and without limitation, a transaction amount that is less than $50 might define a first event condition; a transaction amount that is greater than $50 but less than $500 might define a second event condition; and a transaction amount that is greater than $500 might define a third event condition.

At step 204, the user defines (or selects, depending on implementation) time-based event conditions. In one embodiment, time-based event conditions comprise event conditions that are based on cumulative transaction amounts (in currency) in a specified time period relative to a threshold value. For example and without limitation, a cumulative transaction amount that is less than $100 over a one-month time period might define a first event condition; a cumulative transaction amount that is greater than $100 but less than $500 over the same one-month time period might define a second event condition; and a cumulative transaction amount that is greater than $500 over the same time period might define a third event condition.

At step 206, the user defines (or selects, depending on implementation) geography-based event conditions. In one embodiment, geography-based event conditions comprise event conditions that are based on the location where the transaction was initiated relative to a specified geographic area. For example and without limitation, a transaction that is initiated within the home state of the user might define a first event condition; and a transaction that is initiated outside of the user's home state might define a second event condition.

At step 208, the user defines (or selects, depending on implementation) authentication challenge rules corresponding to occurrence(s) of the different event conditions. In one embodiment, the authentication challenge rules define how many challenges are to be triggered (e.g., one-factor, two-factor or three-factor authentication) upon occurrence of the different event conditions. Alternatively or additionally, the authentication challenge rules may specify designated actions to be taken or particular types of challenges that are to be triggered upon occurrence of different event conditions; or a number of authentication failures that will result in rejecting the transaction and/or locking the account.

The authentication challenges and associated data are stored in the authentication challenges database 124. The authentication challenges may comprise, for example and without limitation, passwords/PINs, personal questions, biometric information, special issued cards or token or a phone call to a specific number. As will be appreciated, the authentication challenges may be applied in any form or combination depending on the specified authentication rules.

According to one embodiment, it is contemplated that the authentication rules will specify one-factor authentication for relatively benign events (e.g., for low transaction amounts, where multi-factor authentication may become a nuisance) and will specify multi-factor authentication for events in which security is a greater concern (e.g., for higher transaction amounts).

For example and without limitation, referring to the exemplary amount-based event conditions described at step 202, a transaction amount that is less than $50 (satisfying the first event condition) might trigger one-factor authentication according to a first rule; a transaction amount that is greater than $50 but less than $500 (satisfying the second event condition) might trigger two-factor authentication according to a second rule; and a transaction amount that is greater than $500 (satisfying the third event condition) might trigger three-factor authentication including a phone call to the user according to a third rule.

As a further example, referring to the exemplary time-based event conditions described at step 204, a cumulative transaction amount that is less than $100 over a one-month time period (satisfying the first event condition) might trigger one-factor authentication according to a first rule; a cumulative transaction amount that is greater than $100 but less than $500 over the same one-month time period (satisfying the second event condition) might trigger two-factor authentication according to a second rule; and a cumulative transaction amount that is greater than $500 over the same time period (satisfying the third event condition) might trigger three-factor authentication according to a third rule.

Finally, referring to the exemplary geographic-based event conditions described at step 206, a transaction that is initiated within the user's home state (satisfying the first event condition) might trigger one-factor authentication according to a first rule; and a transaction that is initiated outside of the user's home state (satisfying the second event condition) might trigger two-factor authentication according to a second rule.

At step 210, the event definitions and rules are stored in the event definition and rules database 126. In one embodiment, the event definitions and rules are stored by operation of the application platform 106 automatically responsive to user definition (or selection, depending on implementation) of the respective events and rules at steps 202, 204, 206 and 208 and are themselves protected with multi-factor authentications so as to prevent unauthorized access. In one embodiment, for example, following initial creation of the event definitions and rules, the user may wish to modify or add new event definitions or rules, turn them on or off or apply them in different combinations. The user may do so by conveying information and/or instructions associated with the events and/or rules to the application platform 106 and/or service platform 110 provided they are first authenticated by the application platform and/or service platform using multi-factor authentication.

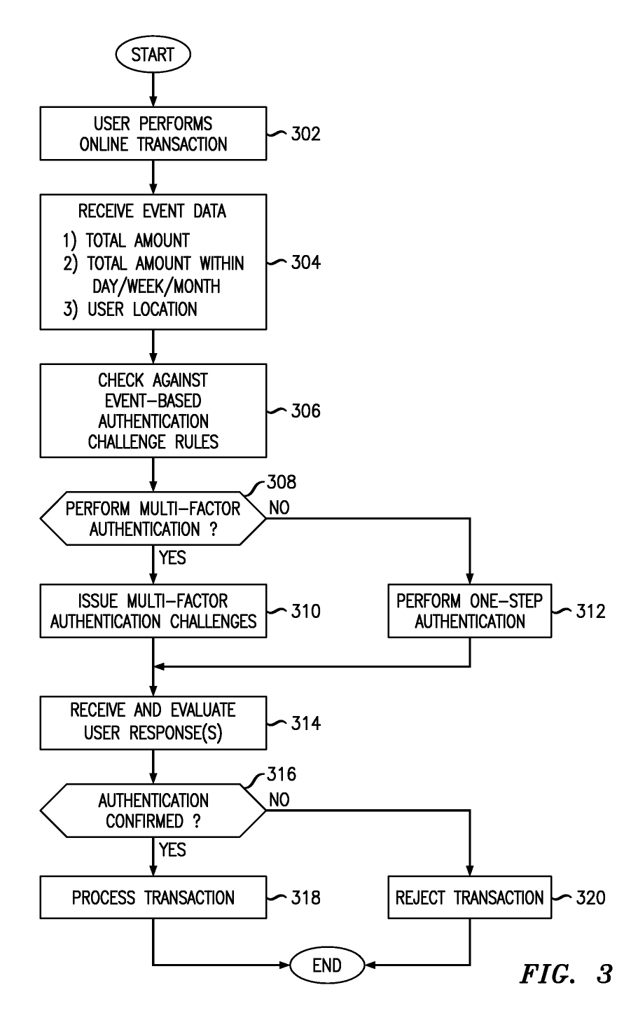

FIG. 3 is a flowchart showing steps associated with the event-based challenge process 122 according to an embodiment of the present invention. Generally, the event-based challenge process 122 operates on a transaction by transaction basis to recognize whether predefined event condition(s) have occurred and upon occurrence of such events to trigger authentication challenges according to predetermined rules, where the event definitions and rules have been defined in advance of the transaction in a process such as described in relation to FIG. 2. The steps of FIG. 3 may be performed, where applicable, by the user 108, the user platform 102, the application platform 106 and/or the service platform 110.

At step 302, the user 108 performs an online transaction, for example and without limitation, by operating the user platform 102 to access and interact with the service platform 110 in conjunction with the application platform 106, where applicable, to conduct electronic commerce, mobile commerce or online banking transactions or to access online information content. It is contemplated, for example, that the application platform may perform authentication functions, according to the predefined event definitions and rules, on behalf of the service platform. Alternatively, authentication functions may be performed in whole or in part by the service platform 110.

At step 304, the application platform 106 (or service platform, depending on implementation) receives “event data” (e.g., indicia of transaction amount, cumulative transaction amount, or geographic location where the transaction was initiated) and evaluates the event data relative to the predefined event conditions to identify triggering events. As previously noted, a triggering event occurs when an instance of event data satisfies a predefined event condition. For example, in embodiments where predefined event conditions comprise amount-based, time-based and geography-based event conditions such as described in relation to FIG. 2, the application platform 106 or service platform 110 receives and evaluates indicia of individual transaction amounts, cumulative transaction amounts in a specified time period, and indicia of the location where the transaction was initiated to determine whether any of the predefined event conditions have occurred, whereby the occurrence of any of such event conditions identifies a triggering event.

At step 306, the application platform (or service platform, depending on implementation) compares transaction event results with the predetermined rules defined (or selected) by the user corresponding to the predefined events. Therefore, to the extent that any triggering events have occurred, the application platform or service platform will identify and issue the corresponding authentication challenge(s) specified by the rules.

If a triggering event has occurred for which the rules specify multi-factor authentication, determined at decision block 308, the application platform or service platform issues the specified multi-factor challenges at step 310. If the rules do not specify multi-factor authentication, the application platform or service platform performs one-step authentication at step 312. Responsive to steps 308, 310, 312, the user supplies the credentials requested by the multi-factor authentication challenges or one-step authentication, as appropriate; and the application platform or service platform receives and evaluates the user responses at step 314.

At step 316, the application platform or service platform determines whether the challenges were sufficiently answered (i.e., whether the responses were sufficiently accurate to authenticate the user and authorize the transaction). For example, depending on implementation, the application platform or service platform might require that all of the challenges are answered successfully, or may permit a certain number or percentage of failed responses as long as a significant number or percentage responses are answered correctly.

If the challenges are sufficiently answered, the application platform or service platform confirms authentication and allows the transaction to proceed (in the case of the application platform) or processes the transaction (in the case of the service platform) at step 318. Conversely, if the challenges are not sufficiently answered, the application platform or service platform rejects the transaction at step 320. Optionally, the application platform or service platform may lock the user account following a rejected transaction so as to block further transaction attempts from the user.

FIGS. 1-3 and the foregoing description depict specific exemplary embodiments of the invention to teach those skilled in the art how to make and use the invention. The described embodiments are to be considered in all respects only as illustrative and not restrictive. The present invention may be embodied in other specific forms without departing from the scope of the invention which is indicated by the appended claims. All changes that come within the meaning and range of equivalency of the claims are to be embraced within their scope.

For example, the term “online transaction” as used herein is generally defined as any electronic commerce, mobile commerce, point-of-sale transaction or online banking or securities transactions including, but not limited to monetary transactions or transactions in which a user (i.e., person conducting the transaction) accesses online information content. The user will nominally comprise the first-party customer, purchaser, account holder or the like but may also comprise a third-party (e.g., such as an operator of a point-of-sale terminal) that accesses online information content for purpose of cardholder verification or other form of customer authentication.

The term “user platform” as used herein is generally defined as any computer or telephony device comprising, for example and without limitation, a laptop computer, desktop computer or mobile computing device, PSTN (POTS) telephone or point-of-sale terminal which is subject to operation by a user 108 to interact with the service platform 110 and/or application platform 106 to conduct an online transaction. In exemplary embodiments described herein, the user platform includes a web browser for interacting with the service platform and/or application platform. As will be appreciated, however, the user platform may be implemented in alternative modalities. For example, the user platform may include a banking/e-commerce client application or may include an electronic wallet alternatively or additionally to a web browser.

The term “application platform” as used herein is generally defined as any computer device or software application residing remotely from the user platform that executes an application program to perform some kind of activity or transaction with a user. The application platform may include, without limitation, web-based platforms, or platforms residing internal to the firewall of a business or government enterprise; and the activity or transaction may include, without limitation, banking or financial transactions, e-commerce, gaming, communications or social networking transactions.

The term “event conditions” has been described with reference to specific exemplary embodiments, wherein predefined event conditions comprise amount-based, time-based and geography-based event conditions; and the term “event data” has been described with reference to corresponding data (e.g., indicia of transaction amount, cumulative transaction amount, or geographic location where the transaction was initiated) that is evaluated relative to the predefined event conditions to identify triggering events. However, it will be appreciated that event conditions and corresponding event data may be defined based on generally any transaction characteristic(s), alternatively or additionally to amount-based, time-based and geography-based event conditions. For example, and without limitation, event conditions and corresponding event data might be based on time of day of the transaction(s), network address where the transaction(s) are initiated, etc.

The term “multi-factor authentication” as used herein is generally defined as any authentication scheme that provides for issuing multiple authentication challenges, i.e., greater than single-factor authentication. It will be understood that while embodiments of the present invention provide for multi-factor authentication responsive to certain user-configurable triggering events, it does not require multi-factor authentication in every instance. For example, it is contemplated that the system may be configured to issue single-factor authentication for certain triggering events and multi-factor authentication for certain other triggering events.

It should be understood that the term “processor” as used herein is intended to include one or more processing devices, including a central processing unit (CPU) or other processing circuitry, including but not limited to one or more signal processors, one or more integrated circuits, and the like. Also, the term “memory” as used herein is intended to include memory associated with a processor or CPU, such as RAM, ROM, a fixed memory device (e.g., hard drive), or a removable memory device (e.g., diskette or CDROM).

1. Apparatus for providing event-driven authentication associated with one or more online transactions of a user, in accordance with a communication system including a user platform operably connected to an application platform, the apparatus at the application platform comprising:
a memory; and
at least one processor coupled to the memory and configured to:
receive event data associated with one or more online transactions of the user;
evaluate the event data relative to a plurality of predefined event conditions to identify occurrences of any triggering events;
upon occurrence of at least one triggering event,
identify authentication challenge rules corresponding to the at least one triggering event, and
issue one or more authentication challenges according to the authentication challenge rules.

2. The apparatus of claim 1, wherein the authentication challenge rules specify using multi-factor authentication upon occurrence of at least one triggering event.

3. The apparatus of claim 1, wherein the at least one triggering event includes at least a first and second triggering event, and wherein the authentication challenge rules specify using a first number of authentication challenges upon occurrence of the first triggering event and a second number of authentication challenges upon occurrence of the second triggering event, wherein the second number is greater than the first number.

4. The apparatus of claim 3, wherein the authentication challenge rules specify using single-factor authentication upon occurrence of the first triggering event and multi-factor authentication upon occurrence of the second triggering event.

5. The apparatus of claim 1, wherein the at least one triggering event comprises one or more amount-based events, wherein the predefined event conditions comprise indicia of individual transaction amounts.

6. The apparatus of claim 1, wherein the at least one triggering event comprises one or more time-based events, wherein the predefined event conditions comprise indicia of cumulative transaction amounts over a specified time period.

7. The apparatus of claim 1, wherein the at least one triggering event comprises one or more geography-based events, wherein the predefined event conditions comprise indicia of where respective transactions are initiated relative to a specified geographic area.

8. The apparatus of claim 1, wherein the at least one triggering event comprises a combination of:
one or more amount-based events, wherein the predefined event conditions comprise indicia of individual transaction amounts; and
one or more time-based events, wherein the predefined event conditions comprise indicia of cumulative transaction amounts over a specified time period.

9. The apparatus of claim 1, wherein the at least one triggering event comprises a combination of:
one or more amount-based events, wherein the predefined event conditions comprise indicia of individual transaction amounts;
one or more time-based events, wherein the predefined event conditions comprise indicia of cumulative transaction amounts over a specified time period; and
one or more geography-based events, wherein the predefined event conditions comprise indicia of where respective transactions are initiated relative to a specified geographic area.

10. Method for providing event-driven authentication associated with one or more online transactions of a user, in accordance with a communication system including a user platform operably connected to an application platform, the method comprising the application platform:
receiving event data associated with one or more online transactions of the user;
evaluating the event data relative to a plurality of predefined event conditions to identify occurrences of any triggering events;
upon occurrence of at least one triggering event,
identifying authentication challenge rules corresponding to the at least one triggering event, and
issuing one or more authentication challenges according to the authentication challenge rules.

11. The method of claim 10, wherein the step of issuing one or more authentication challenges comprises issuing multi-factor authentication upon occurrence of at least one triggering event.

12. The method of claim 10, wherein the at least one triggering event includes at least a first and second triggering event, and wherein the step of issuing one or more authentication challenges comprises issuing a first number of authentication challenges upon occurrence of the first triggering event and a second number of authentication challenges upon occurrence of the second triggering event, wherein the second number is greater than the first number.

13. The method of claim 12, wherein the step of issuing one or more authentication challenges comprises issuing single-factor authentication upon occurrence of the first triggering event and multi-factor authentication upon occurrence of the second triggering event.

14. The method of claim 10, wherein the at least one triggering event comprises one or more amount-based events, wherein the predefined event conditions comprise indicia of individual transaction amounts.

15. The method of claim 10, wherein the at least one triggering event comprises one or more time-based events, wherein the predefined event conditions comprise indicia of cumulative transaction amounts over a specified time period.

16. The method of claim 10, wherein the at least one triggering event comprises one or more geography-based events, wherein the predefined event conditions comprise indicia of where respective transactions are initiated relative to a specified geographic area.

17. The method of claim 10, wherein the at least one triggering event comprises a combination of:
one or more amount-based events, wherein the predefined event conditions comprise indicia of individual transaction amounts; and
one or more time-based events, wherein the predefined event conditions comprise indicia of cumulative transaction amounts over a specified time period.

18. The method of claim 10, wherein the at least one triggering event comprises a combination of:
one or more amount-based events, wherein the predefined event conditions comprise indicia of individual transaction amounts;
one or more time-based events, wherein the predefined event conditions comprise indicia of cumulative transaction amounts over a specified time period; and
one or more geography-based events, wherein the predefined event conditions comprise indicia of where respective transactions are initiated relative to a specified geographic area.

19. An article of manufacture comprising a processor-readable storage medium storing one or more software programs which when executed by a processor associated with the application platform perform the steps of the method of claim 10.
